(19) United States
(12) Patent Application Publication
(10) Pub. No.: US 2021/0246909 A1
(43) Pub. Date: Aug. 12, 2021

(54) CANISTER-TYPE FAN STRUCTURE

(71) Applicant: MYUNGSUNG INC., Daegu (KR)

(72) Inventors: Myeong Yong KIM, Daegu (KR); II Seong HONG, Gyeongsan-si (KR)

(21) Appl. No.: 17/055,562

(22) PCT Filed: Sep. 17, 2019
(86) PCT No.: PCT/KR2019/011973

§ 371 Date: Nov. 14, 2020

(30) Foreign Application Priority Data
Oct. 30, 2018 (KR) 10-2018-0130406
Aug. 20, 2019 (KR) 10-2019-0102002

(51) Int. Cl. F04D 29/70; F04D 29/52

(52) U.S. Cl. CPC F04D 29/703; F04D 29/522

(57) ABSTRACT

The present invention relates to a canister-type fan structure and, more specifically, to a canister-type fan structure having a housing, in which wings for generating wind are mounted, of a canister shape having a certain standard to improve a wind blowing efficiency. In addition, the canister-type fan structure has safety net bodies having an optimal shape and mounted to front and rear surfaces of the canister-type housing, so as to blow soft wind close to the natural wind. To this end, the canister type fan structure of the present invention comprises: a canister-type housing which is provided with wings for generating the wind rotatably mounted thereon and has predetermined lengths in forward and backward directions from the mounting position of the wings; and a front safety net body which is mounted on the front surface of the canister-type housing and is provided with protecting ribs so that a plurality of wind holes form a certain pattern.

### TECHNICAL FIELD

The present disclosure relates to a canister-type fan structure, and more particularly, to a canister-type fan structure in which a housing in which blades are mounted are formed to have a canister shape and safety net body bodies mounted on front and rear sides of the canister type housing have wind holes (i.e., air holes) having a shape optimal for blowing.

### BACKGROUND ART

In general, fans used at homes or offices are machines that generate wind by electricity, which are home appliances frequently used in hot summer.

Such a fan blows air introduced from the rear toward the front by rotating blades according to driving of a motor, thereby providing cool wind to users during the summer, and here, the fan provides wind to a plurality of people in a wide area. Since the blades of the fan rotate at a high speed, if users' finger or the like comes into contact with the blades, there is a risk of injury, and thus, safety net body bodies are always installed on the front and rear sides of a housing in which the blades is mounted.

Therefore, even with a motor having the same power, a wind speed, blowing direction, blowing distance, and the like may differ depending on the shape and the number of blades that generate wind, a size and a location of a housing in which the blades are mounted, and a shape of safety net body bodies installed on the front and rear sides of the housing, and thus blowing efficiency of the fan vary. In addition, even with wind having the same wind speed, a touch thereof on a user's face or the like may vary depending on a shape of the safety net body bodies of the fan, and such a touch on the user's skin has been admitted as one of important design factors to be considered when fans are developed in line with the trend of recent development of high-end home appliances.

As described above, various researches have been conducted to develop a new type of fan having a high blowing efficiency and a soft skin touch, beyond the conventional type of fan.

One of these research results is disclosed in Japanese Patent Laid-Open Publication No. 2016-029266 (Title of the invention: Breeze Generating net body for Electric fan and indoor cooler, publication date: Mar. 3, 2016). This breeze-generating net body includes a mesh net body for air volume control installed on the front of a housing with blowing blades mounted therein, and the net body for air volume control serves to subdivide a size of an wind hole formed in the mesh net body using a thickness of fiber yarn. Intermittent and non-uniform wind artificially generated by the blowing blades allows creation of a soft breeze close to the natural wind in the process of passing through the mesh net body for air volume control in which the size of the wind hole is subdivided.

However, since the breeze generating net body simply subdivides the size of the wind hole, it increases wind pressure resistance, leading to a problem that blowing efficiency such as a wind speed, a blowing direction, and a blowing distance is significantly deteriorated.

Korean Patent Laid-Open Publication No. 2017-0105822 (Title of the invention: Front Safety net body of Fan, publication date: Sep. 20, 2017) discloses a technical configuration that improves blowing efficiency by improving a shape of a protective mesh forming the safety net body. The front safety net body includes a ring-shaped outer guide having a predetermined width and having open front and rears to improve blowing efficiency of the fan by ensuring straightness of wind generated when blades rotate and a plurality of protective ribs provided on the front of the outer guide to protect the blades and having a spiral shape allowing wind formed through the blades to escape to the outside while generating a vortex, wherein the protective ribs are formed to gradually increase from the rear to the front so that an inner diameter of an wind hole gradually narrows in a direction of blowing to allow wind to escape to the outside in a straight form, without scattering.

However, this front safety net body has a spiral shape to cause a partial eddy current to be formed in front of the safety net body, reducing a blowing distance to degrade blowing efficiency, and the spiral non-uniform wind makes a touch that reaches the user's face different from the soft natural wind, although straightness of the wind is improved.

### DISCLOSURE

### Technical Problem

Therefore, an object of the present disclosure is to provide a canister-type fan structure in which a housing in which blades for generating wind are mounted has a canister shape having a predetermined standard to improve wind blowing efficiency and safety net body bodies mounted on front and rears of the canister type housing are optimized in shape to allow soft-touch wind close to natural wind to be transmitted.

### Technical Solution

According to an aspect of the present disclosure, there is provided a canister-type fan structure including: a canister-type housing including blades rotatably mounted therein to generate wind and having predetermined lengths in forward and backward directions from a mounting position of the blades; and a front safety net body mounted on a front of the canister-type housing and having protective ribs so that a plurality of wind holes form a certain pattern.

In addition, the canister-type housing may have a cylindrical shape having a predetermined length, and a ratio of a front-side length d1 from the mounting position of the blades to a front end to a rear-side length d2 from the mounting position of the blades to a rear end may be 4.5:5.5 to 3:7.

In addition, a diameter of the canister-type housing may have a size of 1.75 to 6.75 times the front-side length d1.

In addition, the canister-type housing may include a rotation support member in which the blades are rotatably mounted therein, and the rotation support member may be located between a longitudinal central line of the canister-type housing and the rear end. Here, the rotation support member may be installed radially.

In addition, the pattern of the wind holes of the front safety net body may have a hexagonal honeycomb pattern. The hexagonal honeycomb pattern may be a uniform honeycomb pattern having the same size over the entire area of the front safety net body or may be a radial honeycomb pattern in which the size of the wind holes gradually increases in a direction from the center of the front safety net body to an outermost side.

In addition, the front safety net body may be divided into a first zone located inside and a second zone located outside a division line formed along a circumferential direction of a predetermined radius from the center thereof, and in the first zone and the second zone, the front safety net body may have a hexagonal honeycomb pattern, and a uniform hexagonal honeycomb pattern in which the hexagonal honeycomb pattern has the same size over the entire area and a radial hexagonal honeycomb pattern in which the size of wind holes gradually increase in the direction from the center of the front safety net body to the outermost side may be formed alternately.

As an embodiment, the first zone of the front safety net body may have the uniform honeycomb pattern, and the second zone may have the radial honeycomb pattern.

In addition, the hexagonal honeycomb pattern may be formed such that a ratio of a height (h) to a width (d) of the wind hole is 1:1.1 to 1:1.25.

In addition, the protective ribs forming the hexagonal honeycomb pattern may be formed to gradually increase in a direction from the rear to the front, which is a blowing direction of wind, so that an inner diameter of the wind holes gradually decreases toward the blowing direction.

Meanwhile, the canister-type fan structure may further include: a rear safety net body mounted on a rear of the canister-type housing and having protective ribs so that a plurality of wind holes form a certain pattern, wherein the wind hole pattern of the rear safety net body may have a hexagonal honeycomb pattern.

Here, the hexagonal honeycomb pattern may be a uniform honeycomb pattern having the same size over the entire area of the rear safety net body or may be a radial honeycomb pattern in which the size of the wind hole gradually increases in a direction from the center of the rear safety net body to the outermost side.

In addition, the rear safety net body may be divided into a first zone located inside and a second zone located outside a division line formed along a circumferential direction of a predetermined radius from the center thereof, and in the first zone and the second zone, the rear safety net body may have a hexagonal honeycomb pattern, and a uniform hexagonal honeycomb pattern in which the hexagonal honeycomb pattern has the same size over the entire area and a radial hexagonal honeycomb pattern in which the size of wind holes gradually increases in the direction from the center of the front safety net body to the outermost side may be formed alternately.

As an embodiment, the first zone of the rear safety net body may have the uniform honeycomb pattern, and the second zone may have the radial honeycomb pattern.

In addition, the hexagonal honeycomb pattern of the rear safety net body may be formed such that a ratio of a height (h) to a width (d) of the wind hole is 1:1.1 to 1:1.25.

In addition, the protective ribs forming the hexagonal honeycomb pattern of the rear safety net body may be formed to gradually increase in a direction from the rear to the front, which is a blowing direction of wind, so that an inner diameter of the wind holes gradually decreases toward the blowing direction.

### Advantageous Effects

In the canister-type fan structure according to embodiments of the present disclosure, since the housing is configured as a canister-type housing and the blades that generate wind are rotatably mounted at an optimal position in the housing, blowing efficiency of the fan such as straightness of wind, a wind speed, a blowing direction, a blowing distance, and the like may be improved on the whole.

In addition, since the hexagonal honeycomb pattern is formed on the front and rear safety net bodies mounted on the canister-type housing, a soft breeze close to natural wind may be generated.

### DESCRIPTION OF DRAWINGS

FIG. 1 is a perspective view of a canister-type fan according to an embodiment of the present disclosure;

FIG. 2 is an exploded perspective view of a canister-type fan according to an embodiment of the present disclosure;

FIG. 3 is a cross-sectional view of a canister-type fan according to an embodiment of the present disclosure;

FIG. 4 is a front view of a safety net body of a fan according to an embodiment of the present disclosure;

FIG. 5 is a front view of a fan safety net body of a fan according to another embodiment of the present disclosure;

FIG. 6 is a front view of a safety net body of a fan according to another embodiment of the present disclosure;

FIG. 7 is a front view of a safety net body of a fan according to another embodiment of the present disclosure;

FIG. 8 is a graph showing a maximum wind speed according to a safety net body of a fan;

FIG. 9 is a view showing a shape of a wind hole of a safety net body of a fan according to the present disclosure;

FIG. 10 is a rear perspective view of a safety net body of a fan according to an embodiment of the present disclosure; and

FIGS. 11, 12, and 13 are partial cross-sectional views showing shapes of wind holes according to cross-sectional shapes of protective ribs of safety net bodies of a fan.

### BEST MODES

The terminologies used herein are only for describing particular embodiments and are not intended to limit the present disclosure. Singular forms as used herein include plural forms unless stated otherwise. The term “comprise” as used herein is used to embody a particular characteristic, region, integer, step, operation, element, and/or component without excluding presence or addition of other particular characteristics, regions, integers, steps, elements, components, and/or groups.

Unless defined otherwise, all terms including the technical or scientific terms as used herein have the same meaning as those commonly appreciated by one of ordinary skill in the art to which the present disclosure pertains. The terms defined in dictionaries commonly used may be construed to comply with those set forth herein and relevant technical documents and should not be interpreted overly ideally or formally unless defined otherwise.

Hereinafter, a canister-type fan structure according to an embodiment of the present disclosure will be described in detail with reference to the accompanying drawings.

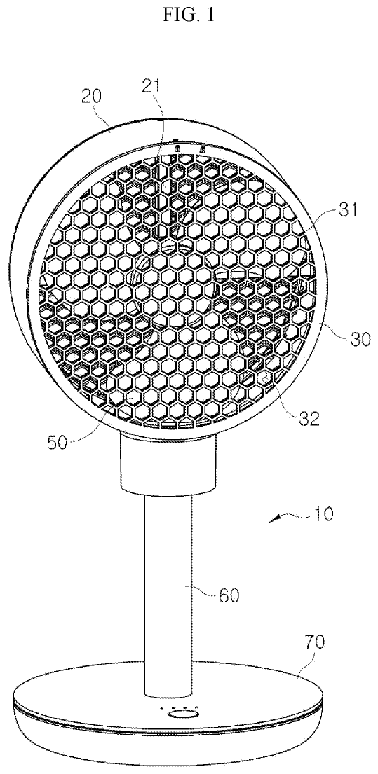

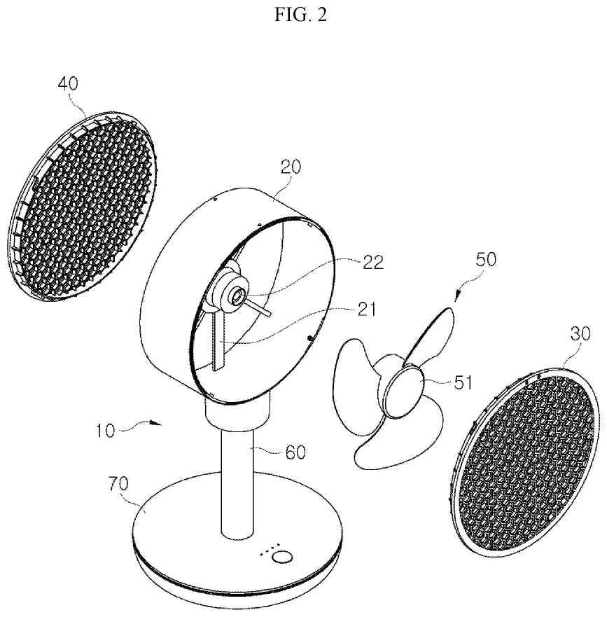

FIG. 1 is a perspective view of a canister-type fan according to the present disclosure, and FIG. 2 is an exploded perspective view thereof. A canister-type fan 10 includes a canister-type housing 20 in which blowing blades 50 are rotatably mounted and safety net bodies 30 and 40 mounted on front and rears of the canister-type housing 20.

The canister-type housing 20 is installed to be located above a lower base 70 configured to be stably placed on the floor by a vertical support 60 by a predetermined height. The canister-type housing 20 is mainly formed of a cylindrical shape or may be formed of a polygonal canister body such as a square cylindrical shape or a hexagonal cylindrical shape in consideration of functions or design aspects.

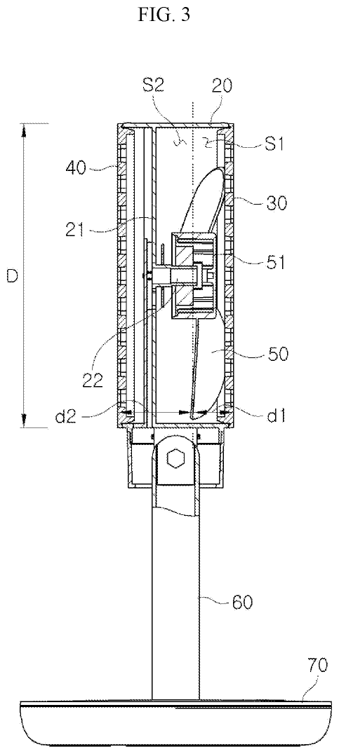

The canister-type housing 20 serves as a blowing channel that introduces wind from the rear when the blades 50 mounted therein rotate at a high speed and allows the introduced wind to pass through the canister-type housing and blow to the front. Blowing efficiency or the like may be improved depending on the standard of the canister-type housing 20 or a positional relationship with the blades 50, and the inventor of the present application designed the canister-type housing 20 that exhibits optimal blowing efficiency through several experiments. This will be described in detail later with reference to FIG. 3.

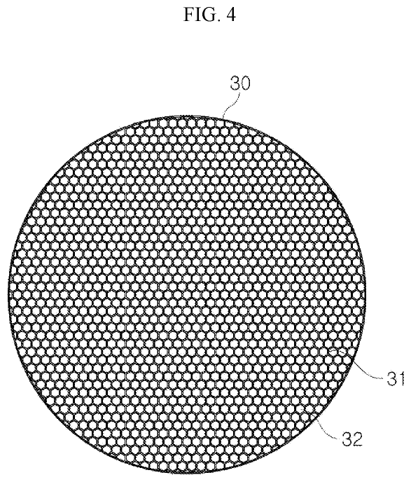

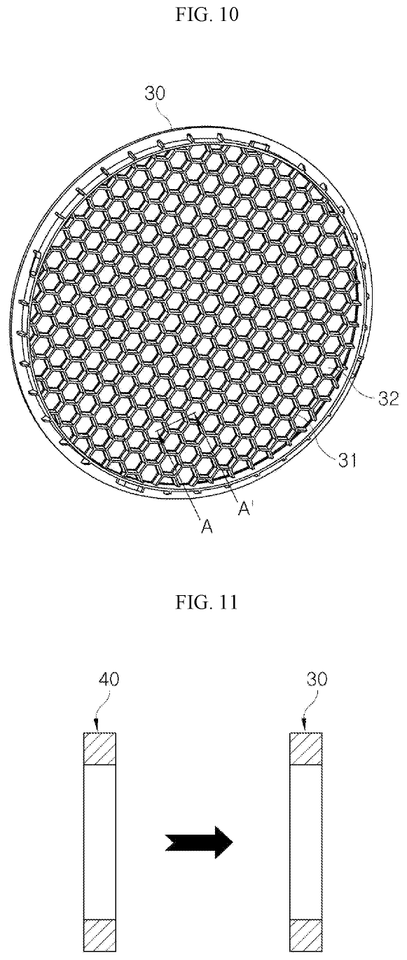

The front safety net body 30 and the rear safety net body 40 are detachably installed on the canister-type housing 20. The safety net body 40 has protective ribs 31 including a plurality of wind holes 32 forming a certain pattern. The protective ribs 31 basically prevent a person's fingers from entering the canister-type housing 30 and colliding with the rotating blades 50, thereby preventing an injury. In addition, the wind holes 32 having a certain pattern formed by the protective ribs 31 may improve the blowing efficiency of wind and a skin touch of the wind. The inventor of the present application designed an optimal safety net pattern through several experiments, and this will be described in detail later with reference to FIGS. 4 to 9. In addition, a cross-sectional shape in a thickness direction of the protective ribs 31 forming the patterns of the safety net bodies 30 and 40 also contributes to controlling the blowing efficiency, which will be described in detail with reference to FIGS. 10 to 13.

FIG. 3 shows a cross-sectional shape of the canister-type housing 20 according to an embodiment of the present disclosure. In this embodiment, the canister-type housing 20 is illustrated to have a cylindrical shape having a predetermined length, but in consideration of functions or design aspects, the canister-type housing 20 may have a polygonal canister body such as a rectangular canister shape as described above. When the canister-type housing 20 has a cylindrical shape, the outermost shape thereof has the same shape as the circular blades 50, and thus they may be designed to be in close contact with each other, enabling optimal space utilization. In addition, since there is no angled corner portion in the longitudinal direction of the housing 20 inside the cylinder, a phenomenon that wind moving straight in a spiral form by rotation of the blades 50 hits the angled corner to cause an eddy current, so a maximum blowing distance is secured to improve the blowing efficiency.

When the canister-type housing 20 has a rectangular canister shape, an extra space may be secured between the rectangular corner portion and the circular blades 50, so that wind moving straight through the interior of the housing in a spiral form may spread to the extra space of the angled corner, thus advantageously securing a larger blowing area. The hexagonal canister shape is an intermediate shape between a cylindrical shape and a square canister shape, and has the characteristics of taking advantage of both. In addition, since the cylindrical shape, the rectangular canister shape, and the hexagonal canister shape have different aesthetics in terms of design, they may be selectively applied in consideration of both the functional aspects and design aspects described above.

Meanwhile, a mounting position of the blades 50 in the canister-type housing 20 is an important design factor controlling the blowing efficiency of wind. The mounting position of the blades 50 is determined depending on where the blades 50 are located in a longitudinal direction of the housing 20. This may be defined as a ratio of a front-side length d1 from the mounting position of the blades 50 to a front end where the front safety net body 30 is installed to a rear-side length d2 from the mounting position of the blades 50 to a rear end where the rear safety net body 40 is installed within the canister type housing 20.

That is, when the ratio of the front-side length di to the rear-side length d2 is 5:5, it means that the blades 50 are located in the middle of the longitudinal direction of the canister-type housing 20. As a result, a front space Si and a rear space S2 from the mounting position of the blades 50 have the same volume. When the blades 50 rotate, air introduced from the rear of the canister-type housing 20 moves straight in a spiral form inside the housing. That is, air scattered outside the canister-type housing 20 is concentrated into the canister-type housing 20 by a rotational force of the blades 50 and forcibly moves straight in a spiral form, so that cool wind having a blowing speed of more than a certain size and a blowing distance are produced.

Here, the rear space S2 from the mounting position of the blades 50 is a space into which external air is introduced and in which wind moving straight in a spiral is first generated. Therefore, as the rear space is larger, the number of rotations and speed in the spiral direction increase, and as a result, the blowing distance of wind increases.

In consideration of this, the ratio of the front-side length d1 to the rear-side length d2 from the mounting position of the blades 50 in the canister-type housing 20 may be 4.5:5.5 to 3:7.

That is, the blades 50 are mounted to be located ahead the center of the canister-type housing 20. If the front-side length d1 is greater than 4.5, that is, if the blades 50 are located at the center of the canister-type housing 20 or further rearward, the rear space S2 from the mounting position of the blades 50 may be reduced and air introduced from the outside of the canister-type housing 20 may not have sufficient rotational and straight movement speed, thus decreasing the blowing distance. In this case, the front space S1 from the mounting position of the blades 50 increases. Here, although wind moves straight in the spiral form in the front space S1 but does not contribute to increasing a final blowing distance of wind than the rear space S2. The reason is considered to be because a force of introducing air from the rear space S2 of the canister-type housing 20 when the blades 50 rotate at a high speed is greater than a force of sending air from the front space S1.

If the front-side length d1 is smaller than 3, that is, if the blades 50 are located closer to the front safety net body 30 in the canister-type housing 20, the final blowing distance of the fan may be reduced. The reason is considered to be because the rear space S2 from the mounting position of the blades 50 significantly increases and the number of times introduced air rotates in a spiral form is increased, resulting in unnecessary air flow such as eddy airflow.

The inventor of the present application experimentally demonstrated the relationship between the mounting position of the blades 50 in the canister-type housing 20 and the blowing efficiency, and the results are shown in [Table 1] and [Table 2] below.

A first experiment summarized in [Table 1] was conducted under the condition that a blade diameter was 30 cm and a blade rotation speed was 1000 RPM. In order to check the blowing efficiency, “near-field wind speed” measured at a 90-cm point which is three times the blade diameter away from the fan and “blowing distance” which is a maximum distance in which a maximum wind speed was measured to be 0.3 m/s or higher. The near-field wind speed was measured three times and then averaged.

TABLE 1

| | | | | | |
|---|---|---|---|---|---|
| d2(cm) | 7.75 | 10.75 | 13.75 | 16.75 | 19.75 |

d1 = 4.75 cm

| | | | | | |
|---|---|---|---|---|---|
| d1:d2 | 3.8:6.2 | 3.1:6.9 | 2.5:7.5 | 2.2:7.8 | 2.0:8.0 |
| Near-field | 3.08 | 3.03 | 3.02 | 3.07 | 3.20 |
| wind speed | | | | | |
| (m/s) | | | | | |
| Blowing | 1510 | 1510 | 1480 | 1480 | 1470 |
| distance | | | | | |
| (cm) | | | | | |

d1 = 7.75 cm

| | | | | | |
|---|---|---|---|---|---|
| d1:d2 | 5:5 | 4.2:5.8 | 3.6:6.4 | 3.2:6.8 | 2.8:7.2 |
| Near-field | 2.96 | 2.82 | 2.76 | 2.70 | 2.82 |
| wind speed | | | | | |
| (m/s) | | | | | |
| Blowing | 1500 | 1510 | 1500 | 1500 | 1470 |
| distance | | | | | |
| (cm) | | | | | |

d1 = 10.75 cm

| d2(cm) | 10.75 | 13.75 | 16.75 | 19.75 |
|---|---|---|---|---|
| d1:d2 | 5:5 | 4.4:5.6 | 4.0:6.0 | 2.5:6.5 |
| Near-field | 2.93 | 2.73 | 2.78 | 2.55 |
| wind speed | | | | |
| (m/s) | | | | |
| Blowing | 1500 | 1520 | 1510 | 1480 |
| distance | | | | |
| (cm) | | | | |

d1 = 13.75 cm

| d2(cm) | 13.75 | 16.75 | 19.75 |
|---|---|---|---|
| d1:d2 | 5:5 | 4.5:5.5 | 4.1:5.9 |
| Near-field | 2.96 | 2.78 | 2.85 |
| wind speed | | | |
| (m/s) | | | |
| Blowing | 1530 | 1530 | 1550 |
| distance | | | |
| (cm) | | | |

d1 = 16.75 cm

| d2(cm) | 16.75 | 19.75 |
|---|---|---|
| d1:d2 | 5.0:5.0 | 4.6:5.4 |
| Near-field | 2.78 | 2.55 |
| wind speed | | |
| (m/s) | | |
| Blowing | 1510 | 1480 |
| distance | | |
| (cm) | | |

As shown in [Table 1] above, after the length of d1 was set to 4.75, 7.75, 10.75, 13.75, and 16.75 cm, a near-field wind speed and a blowing distance of each case based on the ratio of d1:d2 were measured, while changing d2 to 7.75, 10.75, 13.75, 16.75, and 19.75 for each d1. Analyzing the results, it can be seen that both near-field wind speed and blowing distance are high when the ratio of d1:d2 is between 4.5:5.5 and 3.0:7.0. The near-field wind speed is a factor representing the blowing efficiency of an electric fan, and as the near-field wind speed is higher, coolness that the user may feel is greater. The blowing distance refers to a maximum arrival distance of wind at which a minimum wind speed is measured. As the blowing distance is longer, a space that may be covered by a single fan is larger. The near-field wind speed is not always proportional to the blowing distance. For example, in a case where d1=13.75 cm and d2=13.75 cm (d1:d2=5:5), the near-field wind speed is 2.96 m/s and the blowing distance is 1530 cm. In contrast, in a case where d1=13.75 cm and d2=19.75 cm (d1: d2=4.1:5.9), the near-field wind speed is 2.85 m/s and the blowing distance is 1550 cm. That is, it can be seen that, in the case of d1:d2=5:5, the near-field wind speed is larger but the wind speed distance is shorter. Therefore, it can be considered that the blowing efficiency of the fan is better when the near-field wind speed and wind speed distance are uniformly high. The inventor of the present application determined the ratio of d1:d2 to fall between 4.5:5.5 and 3.0:7.0 as a range in which the optimum blowing efficiency is obtained in consideration of both the near-field wind speed and the wind speed distance.

The inventor of present application conducted a second experiment to verify appropriateness of the numerical limitations. The second experiment summarized in [Table 2] was conducted under the condition that the blade diameter was 15 cm and the blade rotation speed was 1885 RPM. “Near-field wind speed” measured at a 45-cm point which is three times the blade diameter away from the fan and “blowing distance” which is a maximum distance in which a maximum wind speed was measured to be 0.3 m/s or higher. The near-field wind speed and the blowing distance were measured three times and then averaged.

TABLE 2

| | | | | | | |
|---|---|---|---|---|---|---|
| d2(cm) | 3 | 5 | 7 | 9 | 11 | 13 |

d1 = 2.5 cm

| | | | | | | |
|---|---|---|---|---|---|---|
| d1:d2 | 4.5:5.5 | 3.3:6.6 | 2.6:7.4 | 2.2:7.8 | 1.8:8.2 | 1.6:8.4 |
| Near-field | 2.84 | 3.06 | 3.06 | 3.27 | 3.03 | 2.70 |
| wind speed | | | | | | |
| (m/s) | | | | | | |
| Blowing | 750 | 760 | 760 | 750 | 740 | 730 |
| distance | | | | | | |
| (cm) | | | | | | |

d1 = 4.5 cm

| | | | | | |
|---|---|---|---|---|---|
| d1:d2 | 4.7:5.3 | 3.9:6.1 | 3.3:6.6 | 2.9:7.1 | 2.6:7.4 |
| Near-field | 2.85 | 2.86 | 2.79 | 2.89 | 2.77 |
| wind speed | | | | | |
| (m/s) | | | | | |
| Blowing | 740 | 750 | 750 | 750 | 740 |
| distance | | | | | |
| (cm) | | | | | |

d1 = 6.5 cm

| | | | | |
|---|---|---|---|---|
| d1:d2 | 4.8:5.2 | 4.2:5.8 | 3.7:6.3 | 3.3:6.6 |
| Near-field | 2.73 | 2.80 | 2.77 | 2.77 |
| wind speed | | | | |
| (m/s) | | | | |
| Blowing | 750 | 750 | 740 | 740 |
| distance | | | | |
| (cm) | | | | |

d1 = 8.5 cm

| d2(cm) | 9 | 11 | 13 |
|---|---|---|---|
| d1:d2 | 4.8:5.2 | 4.4:5.6 | 3.9:6.1 |
| Near-field | 2.69 | 2.73 | 2.77 |
| wind speed | | | |
| (m/s) | | | |
| Blowing | 730 | 740 | 740 |
| distance | | | |
| (cm) | | | |

d1 = 10.5 cm

| d2(cm) | 11 | 13 |
|---|---|---|
| d1:d2 | 4.9:5.1 | 4.5:5.5 |
| Near-field | 2.68 | 2.81 |
| wind speed | | |
| (m/s) | | |
| Blowing | 750 | 750 |
| distance | | |
| (cm) | | |

d1 = 12.5 cm

| d2(cm) | 13 |
|---|---|
| d1:d2 | 4.9:5.1 |
| Near-field | 2.71 |
| wind speed | |
| (m/s) | |
| Blowing | 750 |
| distance | |
| (cm) | |

As shown in [Table 2] above, after the length of d1 was set to 2.5, 4.5, 6.5, 8.5, 10.5, 12.5 cm, a near-field wind speed and a blowing distance of each case based on the ratio of d1:d2 were measured, while changing d2 to 73, 5, 7, 9, 11, 13 for each d1. Analyzing the results, it can be seen that both near-field wind speed and blowing distance are high when the ratio of d1:d2 is between 4.5:5.5 to 3.0:7.0. As described above with reference to [Table 1], the near-field wind speed is not always proportional to the blowing distance, and the blowing efficiency of a fan is better as the near-field wind speed and wind speed distance are uniformly high. Among the values described in [Table 2], in the case of d1=2.5 cm, d2=7 cm (d1:d2=2.6:7.4), the near-field wind speed is 3.06 m/s and the blowing distance is 760 cm, and in the case of d1=2.5 cm, d2=5 cm (d1:d2=3.3:6.6), the near-field wind speed is 3.06 m/s and the blowing distance is 760 cm. That is, in the former case, the ratio of d1:d2 does not fall within the numerical range of the present disclosure, and in the latter case, the ratio of d1:d2 falls within the numerical range of the present disclosure. However, both represents the same excellent values of the near-field wind speed and blowing distance. Meanwhile, in [Table 1], in the case of d1=4.75 cm and d2=13.75 cm (d1:d2=2.5:7.5), both the near-field wind speed and the wind speed distance are low. Based on this, a range in which the ratio of d1:d2 is lower than 3.0:7.0 was excluded from the present disclosure.

Meanwhile, a diameter D of the canister-type housing 20 may have a size of 1.75 to 6.75 times the front-side length d1. As described above, the mounting position of the blades may be set so that the front-side length d1 of the canister-type housing 20 falls within a certain ratio range with the rear length d2. Here, if a preferable ratio range between the diameter D of the canister-type housing 20 and the front-side length d1 is determined, a standard of the canister-type housing 20 in which the best blowing efficiency is achieved, more specifically, the length (d1+d2) of the canister-type housing 20, the diameter D, and the mounting position (the ratio of d1 to d2) of the blades may be determined.

If the diameter D of the canister-type housing 20 is smaller than 1.75 times the front-side length d1, the internal space of the canister-type housing 20 is too small, so air introduced through the canister-type housing 20 cannot obtain a sufficient rotational speed even if the rear-side space S2 from the mounting position of the blades 50 is secured to be large by increasing the rear-side length d2, and thus it is determined that the blowing distance is reduced. In addition, if the diameter D of the canister-type housing 20 is larger than 6.75 times the front-side length d2, the diameter D is too large, compared to the length (d1+d2) of the canister-type housing 20, and the internal space becomes too large in a vertical direction. Also, in this case, a path in which air introduced through the canister-type housing 20 rotates in a spiral form along the inner circumferential surface is too increased to obtain a sufficient rotation speed, and thus it is determined that the blowing distance is reduced.

The canister-type housing 20 has a rotation support member 21 on which the blades 50 are rotatably mounted therein, and the rotation support member 21 may be located between a longitudinal central line of the canister-type housing 20 and a rear end as shown in FIG. 3. As a result, the mounting position of the blades 50 helps to set the ratio of the front-side length d1 to the rear-side length d2 falls within the range of 4.5:5.5 to 3:7 according to the present disclosure. The rotation support member 21 may be installed in a radial form including six supports as shown in FIG. 3. The radial supports provide a structure for stably supporting the blades 50 from various vibrations generated when the blades 50 rotate.

The pattern of the wind holes formed in the front safety net body 30 and the rear safety net body 40 is another important design factor for improving the blowing efficiency of the fan 10. The front safety net body 30 and the rear safety net body 40 may form the same wind hole pattern. Hereinafter, the wind hole pattern of the front safety net body 30 will be described in detail with reference to FIGS. 4 to 9, and the technical configuration and effect of this wind hole pattern may also be applied to the rear safety net body 40 as it is.

As shown in FIGS. 4 to 6, the wind hole pattern of the front safety net body 30 may have a hexagonal honeycomb pattern. The hexagonal honeycomb pattern may be classified into several types.

A first type is a uniform wind hole pattern formed in the same size over the entire area of the front safety net body 30 as shown in FIG. 4. In the uniform wind hole pattern, hexagonal wind holes 32 are formed by protective ribs 31 having a honeycomb structure forming a regular hexagon in which a size of one internal angle is 120°. Here, the protective rib 31 has a width (t) of 0.5 to 1.5 mm and a thickness (w) of 3 to 10 mm depending on strength of a material, and as a result, a height (h) and a width (d) of the wind hole 32 does not exceed 8 mm. In this manner, the front safety net body 30 according to the present disclosure has the wind hole pattern having a hexagonal honeycomb pattern, thereby minimizing resistance to wind by the rotation of the blades 50 to enhance the blowing efficiency and reduce noise occurrence.

In addition, wind having a strong spiral flow generated by the blades 50 is subdivided and becomes a laminar flow in the process of passing through the honeycomb-shaped wind hole pattern having a uniform size, so as to be provided as wind with a smooth touch close to natural wind when reaching a user's face. Thus, since the laminar flow wind is transferred farther, the blowing distance is further increased.

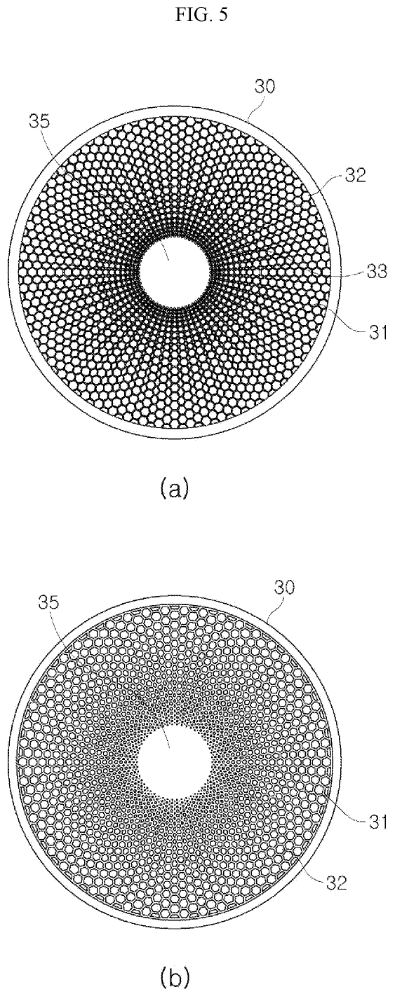

A second type is a radial wind hole pattern in which the size of the wind hole 32 gradually increases in a direction from the center of the front safety net body 30 to the outermost side as shown in FIG. 5. When the front safety net body 30 having a radial honeycomb shape is used, wind may be further subdivided and become a laminar flow to provide a touch close to natural wind and increase the blowing distance, like the uniform wind hole pattern. However, in the radial wind hole pattern, the size of the wind holes decreases toward the center of the safety net body, so a windshield region 35 without a wind hole pattern may be formed near the center. The windshield region 35 interferes with flow of wind to reduce the blowing efficiency, so the windshield region 35 may be formed as small as possible.

In addition, the radial wind hole pattern includes hexagonal wind holes 32 having a first size (large size) and hexagonal wind holes 33 having a second size (small size)) which are alternately formed in a circumferential direction as shown in (a) of FIG. 5, and each of the wind holes 32 and 33 is classified into first radial wind holes 32 whose size gradually decreases in a centrifugal direction and second radial wind holes 32 which have the same hexagonal shape in the circumferential direction and have a size gradually decreases in the centrifugal direction as shown in (b) of FIG. 5. Due to the first radial wind holes 32 having different sizes, wind may be further subdivided to increase the blowing distance as compared with the second radial wind holes, but noise increases due to wind pressure resistance.

A third type is a composite type having both the uniform type and the radial type. As shown in FIG. 6, the front safety net body 30 is divided into a first zone 37 located inside and a second zone 36 located outside a division line formed along a circumferential direction of a certain radius from its center. In the first zone 37 and the second zone 36, the front safety net body 30 has a hexagonal honeycomb pattern, and a uniform hexagonal honeycomb pattern in which the hexagonal honeycomb pattern has the same size over the entire area and a radial hexagonal honeycomb pattern in which the size of wind holes gradually increase in the direction from the center of the front safety net body to the outermost side are formed alternately.

FIG. 6 shows a composite type in which the first zone 37 of the front safety net body 30 is formed in a uniform honeycomb pattern, and the second zone 36 is formed in a radial honeycomb pattern, but conversely, the first zone 37 may be formed in a radial honeycomb pattern and the second zone 36 may be formed in the uniform honeycomb pattern.

When the front safety net body 30 having the composite type honeycomb shape is used, the basic blowing characteristics of the honeycomb-shaped wind hole pattern, in other words, wind may be further subdivided and become a laminar flow to provide a touch close to natural wind and increase the blowing distance. Furthermore, when the composite wind hole pattern is used, wind may be further subdivided and become a laminar flow due to the honeycomb wind holes having different sizes compared to the uniform type, so that the user may feel a softer touch of wind but wind pressure resistance increases to reduce the blowing distance.

As described above, the hexagonal honeycomb pattern according to the present disclosure has various shapes such as uniform type, radial type, and composite type and each has different blowing, noise, and touch characteristics, and thus an appropriate type may be selectively used according to purposes.

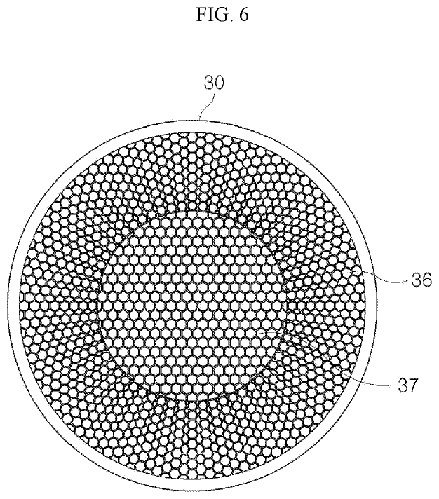

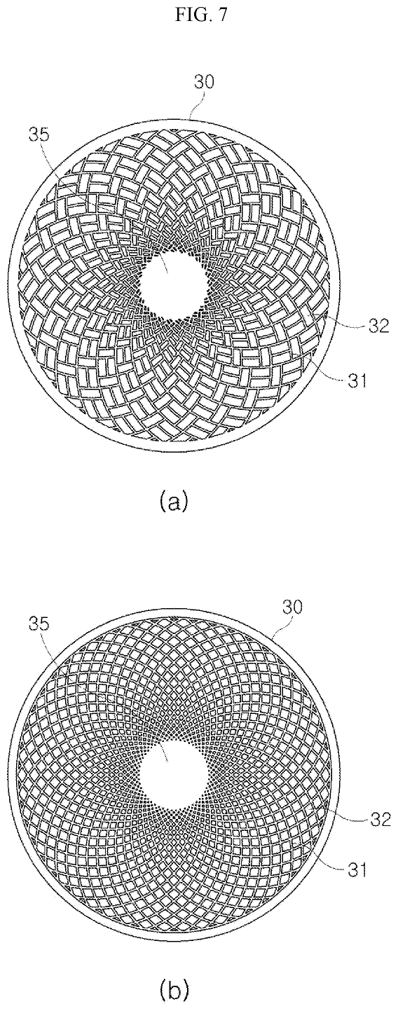

In order to verify the excellent blowing efficiency of the hexagonal-shaped honeycomb pattern, the inventor of the present application made different types of wind hole patterns and compared them through an experiment. The comparative example includes a quadrangular wind hole pattern shown in (a) of FIG. 7 and a rhombic wind hole pattern shown in (b) of FIG. 7. The rectangular wind hole pattern is formed in which the rectangular wind holes 32 are alternately formed horizontally and vertically and the size of the rectangular shape increases toward the outside as the wind holes 32 are spirally spread from the central windshield region 35. Also, the rhombic wind hole pattern is also configured in such a manner that the size of the rhombus increases toward the outside as the rhombic wind holes 32 are spirally spread from the central windshield region 35.

The results of testing the blowing characteristics of the hexagonal honeycomb patterns (uniform type, radial type, and composite type) according to the present disclosure and other types of wind hole patterns are shown in Table 3 below. The rear safety net body 40 having a uniform honeycomb wind hole pattern was mounted on the rear surface of the canister type housing 20, and a wind speed (90 cm distance), a blowing distance (maximum distance in which maximum wind speed of 0.3 m/s or greater is measured), noise, power consumption, and the like were measured, while the front safety net body 30 is changed with various wind hole patterns described above. Each measurement was tested by fixing a measurement distance according to a measurement method specified in KS C 9301.

TABLE 3

| | | Radial | Radial | | | |
|---|---|---|---|---|---|---|
| | | type 1 | type 2 | Composite | | |
| Wind hole | Uniform | (FIG. 5 | (FIG. 5 | type | Rectangular | Rhombic |
| pattern | type | (a)) | (b)) | (FIG. 6) | shape | shape |
| Wind speed | 3.45 | 3.07 | 3.02 | 2.97 | 2.98 | 2.93 |
| (m/s) | | | | | | |
| Blowing | 585 | 485 | 475 | 480 | 460 | 440 |
| distance (cm) | | | | | | |
| Noise (dB) | 62 | 64 | 62 | 60 | 63 | 63 |
| Power | 11.76 | 11.52 | 13.2 | 10.36 | 12.24 | 12.72 |
| consumption | | | | | | |
| (W) | | | | | | |

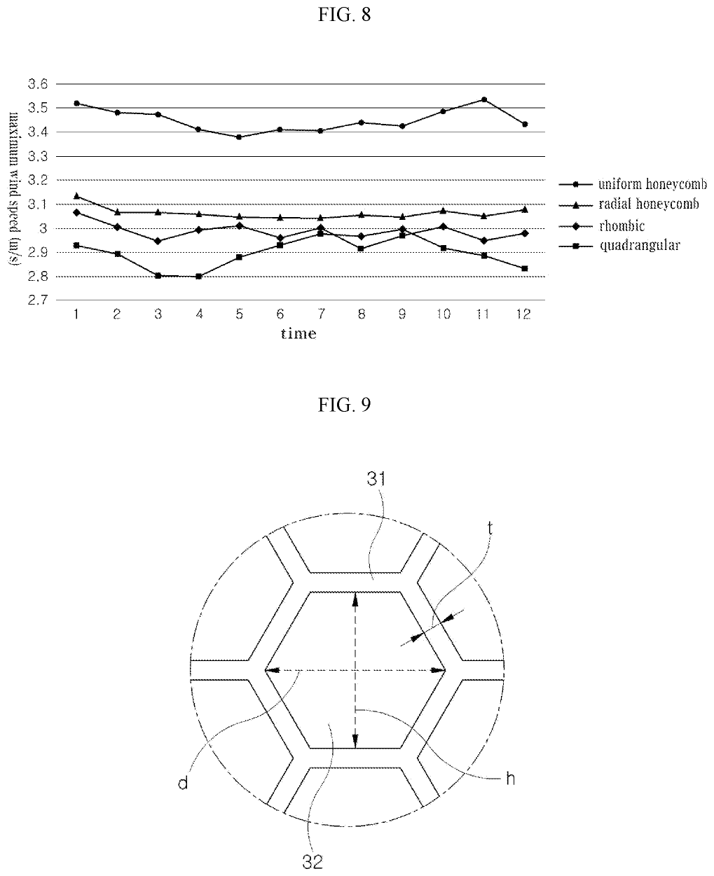

As shown in [Table 3] above, the uniform type honeycomb wind hole pattern exhibited excellent blowing efficiency in all items of wind speed, blowing distance, noise, and power consumption. In particular, the 90 cm wind speed was obtained as an average value through 12 repeated measurements, and as can be seen in the graph shown in FIG. 8, the uniform type wind hole pattern has excellent wind speed characteristics compared to other wind hole patterns. As a result, wind passing through the uniform type wind hole pattern may be subdivided and become a laminar flow, so that it has a soft touch close to natural wind and allows the user to feel more cool due to the strong wind speed. The radial type windshield pattern reduces the wind speed due to the windshield region 35 formed at the center but provides softer wind by subdividing wind further and making a laminar flow. The composite type has excellent soft touch characteristics and low noise and power consumption by reducing wind pressure resistance.

FIG. 9 shows the standard of the wind hole 32 according to the present disclosure. Power was supplied to the fan 10 (in this experiment, 24 v, 2 A power is supplied) and a maximum blowing distance passing through the front safety net body 30 was measured by differentiating the radio of a height (h) to a width (d) of the wind hole 32 in the front safety net body 30 having the same width (t) of 1 mm. As shown in Table 4, the maximum blowing distance [cm] and the wind speed [m/s] at the maximum blowing distance were the highest when the ratio of the height (h) and the width (d) of the wind hole 32 was 1:1.1 to 1:1.25.

TABLE 4

| | Maximum blowing | Wind speed (m/s) at |
|---|---|---|
| | distance | maximum blowing |
| Height (h):width(d) | (cm) | distance |
| X | 1075 | 0.654 |
| 1:0.9 | 1320 | 0.615 |
| 1:0.95 | 1332 | 0.663 |
| 1:1 | 1328 | 0.706 |
| 1:1.05 | 1327 | 0.677 |
| 1:1.1 | 1376 | 0.916 |
| 1:1.15 (Regular hexagon) | 1388 | 0.953 |
| 1:1.2 | 1385 | 0.898 |
| 1:1.25 | 1379 | 0.887 |
| 1:1.3 | 1333 | 0.726 |
| 1:1.35 | 1334 | 0.712 |
| 1:1.4 | 1326 | 0.649 |
| 1:1.45 | 1321 | 0.699 |

In addition, power was supplied to the fan 10 (in this experiment, 24 v, 2 A power is supplied) and a maximum wind speed passing through the front safety net body 30 was measured at the center and left and right points of 5 cm interval from a central line of a blade axis and at a measurement distance of 840 mm by differentiating the radio of a height (h) to a width (d) of the wind hole 32 in the front safety net body 30 having the same width (t) of 1 mm. As shown in Table 5, the maximum wind speed [m/s] was the highest when the ratio of the height (h) and the width (d) of the wind hole 32 was 1:1.1 to 1:1.25.

TABLE 5

| h:d | Left 15 cm | Left 10 cm | Left 5 cm | Front | Right 5 cm | Right 10 cm | Right 15 cm |
|---|---|---|---|---|---|---|---|
| X | 4.182 | 4.117 | 4.228 | 3.625 | 4.385 | 4.171 | 4.118 |
| 1:0.9 | 4.394 | 5.177 | 5.318 | 4.122 | 5.268 | 5.242 | 4.388 |
| 1:0.95 | 4.351 | 5.228 | 5.325 | 4.168 | 5.321 | 5.274 | 4.397 |
| 1:1 | 4.435 | 5.214 | 5.317 | 4.141 | 5.345 | 5.262 | 4.398 |
| 1:1.05 | 4.322 | 5.184 | 5.284 | 4.121 | 5.312 | 5.258 | 4.414 |
| 1:1.1 | 4.778 | 5.785 | 5.841 | 4.678 | 5.878 | 5.764 | 4.825 |
| 1:1.15 | 4.755 | 5.759 | 5.957 | 4.755 | 5.934 | 5.822 | 4.786 |
| 1:1.2 | 4.824 | 5.788 | 5.851 | 4.724 | 5.881 | 5.773 | 4.845 |
| 1:1.25 | 4.785 | 5.782 | 5.812 | 4.685 | 5.852 | 5.794 | 4.787 |
| 1:1.3 | 4.432 | 5.224 | 5.284 | 4.155 | 5.211 | 5.226 | 4.406 |
| 1:1.35 | 4.387 | 5.212 | 5.325 | 4.124 | 5.183 | 5.158 | 4.410 |
| 1:1.4 | 4.358 | 5.188 | 5.293 | 4.153 | 5.194 | 5.151 | 4.367 |
| 1:1.45 | 4.421 | 5.214 | 5.307 | 4.157 | 5.191 | 5.129 | 4.382 |

In other words, Table 5 shows that the center and left and right points of 5 cm interval from a central line of a blade axis were measured at a distance (280 mm×3) three times the blade diameter for 2 minutes using a windmill type anemometer in accordance with the KS 9031 test standard after a sufficient preliminary operation was performed. When an average of highest values of the wind speed at the left and right measurement points was calculated as a maximum wind speed value, it was highest when the ratio of the height (h) and the width (d) of the wind hole 32 was 1:1.1 to 1:1.25. As such, by forming the hexagonal honeycomb wind hole 32 of the front safety net body 30 of the present disclosure to have the ratio of the height (h) and the width (d) as 1:1.1 to 1:1.25, resistance to an airflow that occurs when air blows based on rotation of the blades may be minimized, thereby increasing blowing efficiency and significantly reducing noise occurrence.

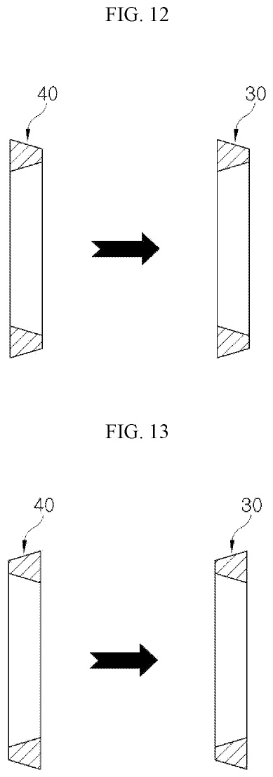

The effect of the shape in the thickness direction of the protective rib 31 forming the wind hole pattern of the front safety net body 30 according to the present disclosure on the blowing efficiency of the fan will be described with reference to FIGS. 10 to 13. As shown in FIG. 10, the following three cases occur according to a cross-sectional shape in the A-A direction of the protective rib 31 forming one wind hole 32 in the front safety net body 30. That is, there may be a case where the thickness of the protective rib 31 is uniform so that a cross-sectional shape thereof is a quadrangular shape as shown in FIG. 11, a case where the protective rib 31 gradually decreases in thickness toward the blowing direction to form a trapezoidal cross-sectional shape and an inner diameter of the wind hole 32 gradually increases as shown in FIG. 12, and a case where the protective rib 31 gradually increases in thickness toward the blowing direction to form an inverse-trapezoidal cross-sectional shape and an inner diameter of the wind hole 32 gradually decreases as shown in FIG. 13.

According to the present disclosure, as shown in FIG. 13, the protective rib 31 is formed to gradually increase in thickness toward the front from the rear, which is the blowing direction of wind, so that the inner diameter of the wind hole 32 gradually decreases toward the blowing direction. As a result, the wind speed increases and the wind speed distance increases by Bernoulli's theorem when wind passes through the narrow wind hole 32. The experimental results of measuring the maximum wind speed and wind speed distance according to the shape of the inner diameter of the wind hole 32 are shown in [Table 6].

TABLE 6

| | Horizontal type | | Extension type | | Reduction type | |
|---|---|---|---|---|---|---|
| Inner | Maximum | Wind speed | Maximum | Wind speed | Maximum | Wind speed |
| diameter of | wind speed | distance | wind speed | distance | wind speed | distance |
| wind hole | (m/s) | (cm) | (m/s) | (cm) | (m/s) | (cm) |
| First time | 3.03 | 750 | 2.75 | 750 | 3.12 | 760 |
| Second time | 2.99 | 755 | 2.63 | 750 | 3.13 | 765 |
| Third time | 3.06 | 755 | 2.72 | 745 | 3.14 | 760 |
| Fourth time | 3.07 | 755 | 2.78 | 750 | 3.13 | 765 |
| Fifth time | 3.08 | 755 | 2.75 | 750 | 3.13 | 765 |
| Average | 3.04 | 754 | 2.72 | 749 | 3.13 | 763 |

As shown in [Table 6], in the case of the reduction type in which the inner diameter of the wind hole 32 gradually decreases toward the blowing direction, both the maximum wind speed and the wind speed distance were excellent as shown in FIG. 13.

The shape in the thickness direction of the wind hole 32 formed on the rear safety net body 40 as well as the front safety net body 30 is another design factor for improving the blowing efficiency of the fan 10. Although only the front safety net body 30 has been described as an example with reference to FIGS. 10 to 13, the technical configuration and effect of the shape of the wind hole 32 in the thickness direction may also be applied to the rear safety net body 40 as it is.

| | |
|---|---|
| 10: fan | 20: canister-type housing |
| 30: front safety net body | 40: rear safety net body |
| 50: blade | 60: vertical support |
| 70: lower base | |

1. A canister-type fan structure comprising:
a canister-type housing including blades rotatably mounted therein to generate wind and having predetermined lengths in forward and backward directions from a mounting position of the blades; and
a front safety net body mounted on a front of the canister-type housing and having protective ribs so that a plurality of wind holes form a certain pattern.

2. The canister-type fan structure of claim 1, wherein the canister-type housing has a cylindrical shape having a predetermined length, and a ratio of a front-side length d1 from the mounting position of the blades to a front end to a rear-side length d2 from the mounting position of the blades to a rear end is 4.5:5.5 to 3:7.

3. The canister-type fan structure of claim 2, wherein a diameter of the canister-type housing has a size of 1.75 to 6.75 times the front-side length d1.

4. The canister-type fan structure of claim 2, wherein the canister-type housing includes a rotation support member in which the blades are rotatably mounted therein, and the rotation support member is located between a longitudinal central line of the canister-type housing and the rear end.

5. The canister-type fan structure of claim 4, wherein the rotation support member is installed radially.

6. The canister-type fan structure of claim 1, wherein the pattern of the wind holes of the front safety net body has a hexagonal honeycomb pattern.

7. The canister-type fan structure of claim 6, wherein the hexagonal honeycomb pattern is a uniform honeycomb pattern having the same size over the entire area of the front safety net body.

8. The canister-type fan structure of claim 6, wherein the hexagonal honeycomb pattern is a radial honeycomb pattern in which the size of the wind holes gradually increases in a direction from the center of the front safety net body to an outermost side.

9. The canister-type fan structure of claim 6, wherein the front safety net body is divided into a first zone located inside and a second zone located outside a division line formed along a circumferential direction of a predetermined radius from the center thereof, and in the first zone and the second zone, the front safety net body has a hexagonal honeycomb pattern, and a uniform hexagonal honeycomb pattern in which the hexagonal honeycomb pattern has the same size over the entire area and a radial hexagonal honeycomb pattern in which the size of wind holes gradually increase in the direction from the center of the front safety net body to the outermost side are formed alternately.

10. The canister-type fan structure of claim 9, wherein the first zone of the front safety net body has the uniform honeycomb pattern, and the second zone has the radial honeycomb pattern.

11. The canister-type fan structure of claim 6, wherein the hexagonal honeycomb pattern is formed such that a ratio of a height (h) to a width (d) of the wind hole is 1:1.1 to 1:1.25.

12. The canister-type fan structure of claim 6, wherein the protective ribs forming the hexagonal honeycomb pattern are formed to gradually increase in a direction from the rear to the front, which is a blowing direction of wind, so that an inner diameter of the wind holes gradually decreases toward the blowing direction.

13. The canister-type fan structure of claim 1, further comprising:
a rear safety net body mounted on a rear of the canister-type housing and having protective ribs so that a plurality of wind holes form a certain pattern,
wherein the wind hole pattern of the rear safety net body has a hexagonal honeycomb pattern.

14. The canister-type fan structure of claim 13, wherein the hexagonal honeycomb pattern is a uniform honeycomb pattern having the same size over the entire area of the rear safety net body.

15. The canister-type fan structure of claim 13, wherein the hexagonal honeycomb pattern is a radial honeycomb pattern in which the size of the wind hole gradually increases in a direction from the center of the rear safety net body to the outermost side.

16. The canister-type fan structure of claim 13, wherein the rear safety net body is divided into a first zone located inside and a second zone located outside a division line formed along a circumferential direction of a predetermined radius from the center thereof, and in the first zone and the second zone, the rear safety net body has a hexagonal honeycomb pattern, and a uniform hexagonal honeycomb pattern in which the hexagonal honeycomb pattern has the same size over the entire area and a radial hexagonal honeycomb pattern in which the size of wind holes gradually increases in the direction from the center of the front safety net body to the outermost side are formed alternately.

17. The canister-type fan structure of claim 16, wherein the first zone of the rear safety net body has the uniform honeycomb pattern, and the second zone has the radial honeycomb pattern.

18. The canister-type fan structure of claim 13, wherein the hexagonal honeycomb pattern of the rear safety net body is formed such that a ratio of a height (h) to a width (d) of the wind hole is 1:1.1 to 1:1.25.

19. The canister-type fan structure of claim 13, wherein the protective ribs forming the hexagonal honeycomb pattern of the rear safety net body are formed to gradually increase in a direction from the rear to the front, which is a blowing direction of wind, so that an inner diameter of the wind holes gradually decreases toward the blowing direction.
